(19) United States
(12) Patent Application Publication
(10) Pub. No.: US 2026/0016233 A1
(43) Pub. Date: Jan. 15, 2026

(54) PLATE STACK OF SUBSTANTIALLY FLAT PLATES

(71) Applicant: ALFA LAVAL CORPORATE AB, Lund (SE)

(72) Inventors: Kristian WALTER, Genarp (SE); Anders SKOGLÖSA, Ramlösa (SE)

(73) Assignee: ALFA LAVAL CORPORATE AB, Lund (SE)

(21) Appl. No.: 19/124,250

(22) PCT Filed: Oct. 25, 2023
(86) PCT No.: PCT/EP2023/079824

§ 371 Date: Apr. 24, 2025

(30) Foreign Application Priority Data
Oct. 28, 2022 (EP) 22204491.9

(51) Int. Cl. F28D 9/00; F28D 21/00

(52) U.S. Cl. CPC F28D 9/005; F28D 2021/0043; F28F 2275/045

(57) ABSTRACT

The present invention relates to a stack of substantially flat plates stacked one on top of the other along a stacking direction. The substantially flat plates define at least a first plate interspace between a first plate and an opposing second plate of the stack. One of the plates in the first plate interspace defining a first ridge protruding a first distance in the first plate interspace. The first distance is less than the thickness of the plates in the first plate interspace. The plates in the first plate interspace being permanently joined at the first ridge.

### TECHNICAL FIELD

The present invention relates to a plate stack of substantially flat plates, a system comprising the plate stack and a method of manufacturing a plate stack of substantially flat plates.

### INTRODUCTION

Plate stacks can be permanently joined by different technologies. Joints may be formed by a joining method in which the plates are subjected to a heat lower than the melting point of the plates. Such joining methods may be brazing with an added brazing material in the form of a foil, a paste, or a powder comprising e.g., copper or nickel.

The above techniques are commonly used for permanently joining corrugated metal plates of permanently sealed heat exchangers. The corrugations of opposing plates contact each other at well defied contact points. The melted brazing material will accumulate at the contact points between the corrugated plates due to capillary forces and wet the contact point and this ensures a proper leak free joint between the plates.

Permanently joining of substantially flat plates is however much more challenging than joining corrugated plates as with flat plates there are no well defied contact points between the plates. Substantially flat plates are particular useful for manufacturing fuel cells, electrolysers or similar, but can also be used in some heat exchanger applications. Substantially flat plates are understood to mean plates defining a plane surface which is intended to be joined to a corresponding plane surface of an opposing plate. However, the plates typically have thoroughgoing channels and port holes for accommodating fluids.

The flat plates are typically permanently joined along the edges of the substantially flat plates or along the port holes by applying brazing material at the edges of the substantially flat plates. However, it will typically not result in a leak free joint. As the opposing plates in practice cannot be positioned perfectly flat relative each other there will typically be a random contact point between the plates when stacked. During stacking of the plates, there will always be areas where there will be more of less play between the opposing plates.

Since the capillary forces are stronger at areas with less distance between the opposing plates and weaker at areas with more distance between the opposing plates, the melted brazing material or plate material will flow from the areas with more play, i.e. greater distance, between the opposing plates to areas with less play, i.e. smaller distance, between the opposing plates. Thus, the areas with more play between the plates may not receive a sufficient amount of melted material and thus may not be sufficiently joined, and there may be leaks at those locations. This is considered a fault.

It is also difficult to ensure that the flat plates are joined at the correct location, i.e. adjacent the edge or adjacent port holes, using flat plates. In case the smallest distance between the plates is closer to the centre of the plate, there is a risk that all or most of the melted material accumulates at that location. This may also lead to a failure. Below follows a short description of some applications of substantially flat plates:

Fuel cells make use of substantially flat plates and generate electrical power from an electrochemical reaction between a hydrogen-based fuel and an oxidant. Fuel cells typically comprise a set of fuel cell substrates assembled in series. Each fuel cell substrate includes a plate package of four (or more) substantially flat metal plates. The fuel cell substate comprising a fuel plate, a separator plate, an oxidant plate and an electrolyte plate positioned between the fuel plate and the oxidant plate. The fuel plate and the oxidant plate each include channels for distributing the fuel and oxidant, respectively. The electrolyte plate comprising an electrolyte material. The separator plate separates the fuel plate and the oxidant plate. An electric current is generated by an electrochemical reaction between the fuel and the oxidant occurring at the electrolyte plate.

Electrolysers also make use of substantially flat plates are used to generate hydrogen and oxygen from water by the use of electrical energy. Electrolysers like fuel cells comprises a set of substantially flat metal plates and may face similar challenges as the fuel cell plates.

The substantially flat plates of fuel cell substrates or electrolysers are successively arranged face to face and joined along their outer edges to be leak tight. They are also joined along port holes. However, as described above, it is very challenging to join flat surfaces due to the lack of a well-defined contact area between the plates. The melted material may therefore, due to capillary forces, accumulate at a random location where there is a small distance or a contact between the plates and leave other areas will be left open. The likelihood of a fault in the joint is therefore very high. A faulty joint may lead to leaks between the plates.

The prior art includes JP 2016176618 describes a plate heat exchanger having circumferential shaped projections having its apex parts brazed to the next plate. Brazing is performed by a brazing material flowing into a gap between opposing plates formed by the projections.

U.S. Pat. No. 4,653,581 describes a plate heat exchanger having side wall members in the form of rods fixed to the heat transfer plates by brazing.

U.S. Pat. No. 10,458,725 describes a plate heat exchanger with flat plates that may have circular rods to form frame members. The plates and the frame will be brazed together to form sealed passageways by capillary flow of molten brazing filler metal.

EP 3 301 747 describes an internally manifolded solid oxide fuel cell stack.

The object of the present invention is therefore to find technologies for permanently joining flat plates without the deficits mentioned above.

### SUMMARY OF THE INVENTION

The object is according to a first aspect of the present invention realized by a stack of substantially flat plates stacked one on top of the other along a stacking direction, the substantially flat plates defining at least a first plate interspace between a first plate and an opposing second plate of the stack, one of the plates in the first plate interspace defining a first ridge protruding a first distance in the first plate interspace, the first distance being less than the thickness of the plates in the first plate interspace, the plates in the first plate interspace being permanently joined at the first ridge.

The plates are made of metal such as stainless steel. They are substantially flat meaning that they are not corrugated or bent. The plates are in particular not corrugated or bent at the location where two opposing plate surfaces are joined together. Some of the plates for the fuel cell application define port holes and/or channels at the inner region for fuel or oxidizer, however, the plates themselves are substantially flat.

By placing a ridge at the position where the plates are joined, there will be a well-defined contact area between the plates. The ridge is elongated to form an enclosed inner region The ridge between the plates will define the minimal play between the plates and will therefore ensure that the melted braze filler accumulates at the ridge. Therefore, the joining of the plates will be free of any faults. The ridge can preferably define a curvature to increase the capillary force between the plates.

The stack comprises at least two plates defining a plate interspace between themselves. The plate interspace typically is very small. It essentially defines a contact plane between the plates. The first distance defines the height of the ridge and is less than the thickness of the plate. As the plates are typically very thin, the ridge will not influence the flow or establish a flow channel in the interspace but just establish a well-defined contact point for the joining of the plates. The plates are typically less than 1 mm and thus the first distance, i.e. the height of the ridge, is also less than 1 mm, however, typically less than 0.1 mm.

According to a further embodiment of the first aspect, the stack of substantially flat plates defining at least a second plate interspace between a third plate and one of the plates in the first plate interspace, one of the plates in the second plate interspace defining a second ridge protruding a second distance in the second plate interspace, the second distance being less than the thickness of the plates in the second plate interspace, the plates in the second plate interspace being permanently joined at the second ridge.

The stack may comprise at least three plates defining a first and a second plate interspace between themselves.

According to a further embodiment of the first aspect, the stack of substantially flat plates defining at least a third plate interspace between a fourth plate and one of the plates in the first plate interspace or second plate interspace, one of the plates in the third plate interspace defining a third ridge protruding a third distance in the third plate interspace, the third distance being less than the thickness of the plates in the third plate interspace, the plates in the third plate interspace being permanently joined at the third ridge.

The stack may also comprise at least four plates defining a first, a second and a third plate interspace between themselves.

According to a further embodiment of the first aspect, at least one of the ridges comprising a brazing material.

Although different technologies can be used for permanently joining the plates, it is preferred to use a brazing material. The brazing material can preferably be applied by printing, such as screen printing, directly on the ridge. To reduce the risk of brazing material flowing away from the ridge, it can be deposited directly onto the ridge. Printing techniques can be used for an accurate deposit of brazing material onto the ridge.

Brazing material has a melting temperature lower than the metal of the plates and thus when the plates are heated above the melting point of the brazing material, it becomes liquid and fills the gap between the plates by capillary action. When cooled down the brazing material solidifies to form the joint.

According to a further embodiment of the first aspect, at least one of the ridges is coined or pressed, or the ridge being a cylindrical rod.

Pressing techniques may be used to form the ridge, However, by using coining techniques, a ridge can be formed without any valley on the opposite side. This can be beneficial when joining more than two plates along the same path since then the ridges in adjacent contact planes of adjacent plates will not influence each other. Alternatively, a separate rod can be used which also does not produce any valley on the opposite side of the plate.

According to a further embodiment of the first aspect, at least one of the plates has a pressed ridge in one of the plate interspaces creating a valley on the opposite side of the plate, the ridges of adjacent plate interspaces being offset in relation to each other.

When using pressing technique, the ridge will cause a valley on the other side of the plate. This causes a problem when joining more than two plates along the same path as the ridge on one plate may then coincide with the valley of the opposite plate in the contact plane. This may cause a leakage as the ridge will fall into the valley, causing a larger distance between the plates and cancelling the effect of the ridge. The ridges in adjacent contact planes of adjacent plates should therefore be offset and should not coincide or cross each other.

According to a further embodiment of the first aspect, at least one of the ridges encircling the plate adjacent an edge of the plate, or, the plates comprise port holes and at least one of the ridges encircling the port hole.

Allowing the ridge to encircle the plates with allows the plate interspace to form an inner region which is fluid tight. Port holes can be used to introduce fuel and oxidiser into the fuel cell and can be encircled at the plate interspaces in which the ports are not used.

The object is according to a second aspect of the present invention realized by a system comprising the plate stack according to any of the above-mentioned embodiments, the system being a fuel cell or an electrolyser.

Fuel cells and electrolysers are examples of applications where substantially flat plates are used.

The object is according to a third aspect of the present invention realized by a method of manufacturing a stack of substantially flat plates comprising the steps of: stacking the substantially flat plates one on top of the other along a stacking direction, the substantially flat plates defining at least a first plate interspace between a first plate and an opposing second plate of the stack, one of the plates in the first plate interspace defining a first ridge protruding a first distance in the first plate interspace, the first distance being less than the thickness of the plates in the first plate interspace, and permanently joining the plates in the first plate interspace at the first ridge.

The above method according to the third aspect is preferably used together with the stack of plates according to the first aspect.

### BRIEF DESCRIPTION OF THE DRAWINGS

FIG. 1A-B are side cross-sectional views of a stack with 2 plates having pressed ridges.

FIG. 2A-B are side cross-sectional views of a stack with 3 plates having pressed ridges.

FIG. 3A-B are side cross-sectional views of a stack with 4 plates having pressed ridges.

FIG. 4A-B are side cross-sectional views of a stack with 4 plates having rod ridges.

FIG. 5A-B are side cross-sectional views of a stack with 4 plates having coined ridges.

FIG. 6 is a perspective view of a stack before permanent joining of the plates.

FIG. 7 is a perspective view and a closeup of a stack after permanent joining of the plates.

### DETAILED DESCRIPTION OF THE DRAWINGS

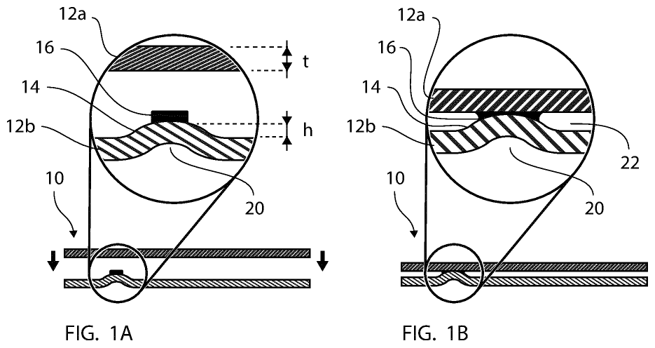

FIG. 1A shows a side cross-sectional view of a stack of substantially flat plates 10 defining a first substantially flat plate 12a and a second substantially flat plate 12b both made of metal, typically stainless steel. The second substantially flat plate 12b defines a pressed ridge 14 having a height h being less than the thickness t of the plate. The height of the ridge 14 relative to the thickness t of the plate can be much less than illustrated, such as less than 1/10 of the thickness t of the plate. The heigh h can be less than 1 mm, preferably less than 0.1mm. The ridge 14 has a brazing material 16 applied to it. The brazing material can be made of e.g. copper or nickel. The brazing material can be applied by e.g. screen printing. The ridge 14 is made by pressing, thus producing a valley 20 on the opposite side of the second substantially flat plate 12b.

FIG. 1B shows a side cross sectional view of the stack of substantially flat plates 10 when the first substantially flat plate 12a and the second substantially flat plate 12b have been brazed together at the ridge 16. The first substantially flat plate 12a and the second substantially flat plate 12b define a plate interspace 22 between themselves. The plate interspace 22 is about equal to the height of the ridge 14. By heating the stack 10 above the melting temperature of the brazing material 16 but below the melting temperature of the second substantially flat plate 14, the brazing material 16 is melted and wets the surface of the ridge 14 and the adjacent surface of the first substantially flat plate 12a. When solidified the brazing material 16 permanently joins the first substantially flat plate 12a and the second substantially flat plate 12b. The ridge 14 creates a well-defined contact area where the capillary forces can ensure that the melted brazing material 16 is accommodated between the ridge 14 and the adjacent surface of the first substantially flat plate 12a. The curved shape of the ridges allow brazing material to accumulate even better at the ridges due to the capillary effect. In this way the liquid brazing material 16 is kept at a well-defined position until it solidifies.

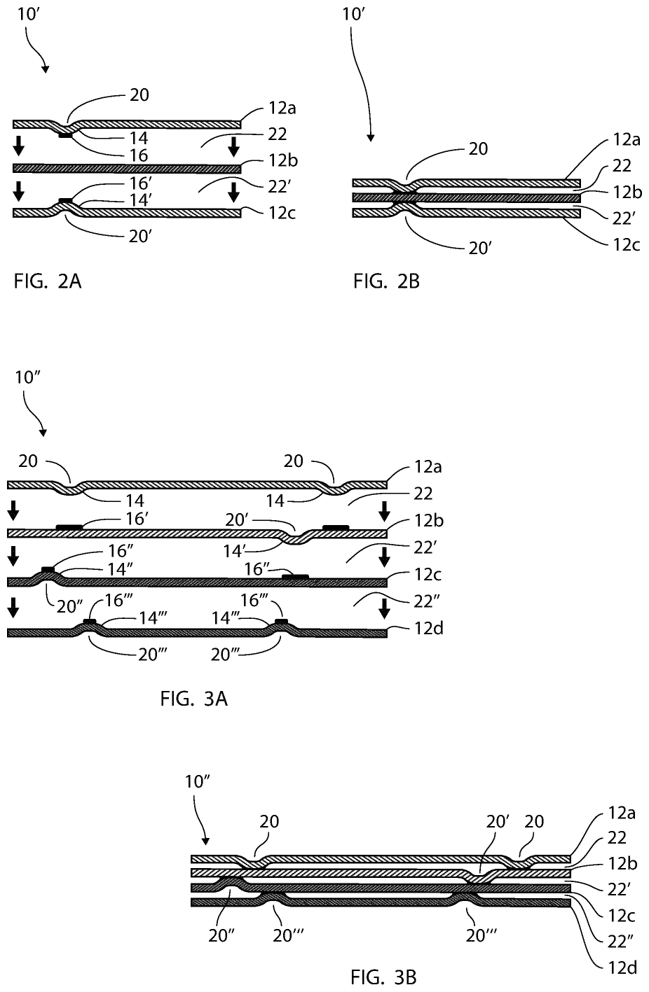

FIG. 2A shows a side cross sectional view of a stack of substantially flat plates 10′ defining a first substantially flat plate 12a, second substantially flat plate 12b and a third substantially flat plate 12c. The first substantially flat plate 12a and the third substantially flat plate 12c each has a pressed ridge 14 14′ facing the second substantially flat plate 12b. The second substantially flat plate 12b is in between and does not have any ridge/valley. Each ridge 14 14′ has a brazing material 16 16′ applied to it. The first substantially flat plate 12a and the second substantially flat plate 12b defines a plate interspace 22 between themselves and the third substantially flat plate 12c and the second substantially flat plate 12b defines a plate interspace 22′ between themselves.

FIG. 2B shows a side cross sectional view of the stack of substantially flat plates 10′ when the first substantially flat plate 12a, the second substantially flat plate 12b and the third substantially flat plate 12c have been brazed together, similar to FIG. 1B.

FIG. 3A shows a side cross sectional view of a stack of substantially flat plates 10″ defining a first substantially flat plate 12a, second substantially flat plate 12b, a third substantially flat plate 12c and a fourth substantially flat plate 12d. The first substantially flat plate 12a has two ridges 14 facing the second substantially flat plate 12a, the second substantially flat plate 12b has one ridge 14′ facing the third substantially flat plate 12c, the third substantially flat plate 12c has a ridge 14″ facing the second substantially flat plate 12b. The fourth substantially flat plate 12d has two ridges 14″ which are facing the third substantially flat plate 12c. The ridges 14 14′ of the first substantially flat plate 12a and the second substantially flat plate 12b are offset to prevent the ridge 14 to fall into the valley 20′. This would have cancelled the effect of the ridge 14. Similarly, the ridges 14″ 14′″ of the third substantially flat plate 12c and the fourth substantially flat plate 12d are offset to prevent the ridge 14′″ to fall into the valley 20′. The first substantially flat plate 12a and the second substantially flat plate 12b defines a plate interspace 22 between themselves and the third substantially flat plate 12c and the second substantially flat plate 12b defines a plate interspace 22′ between themselves. In addition, the third substantially flat plate 12c and the fourth substantially flat plate 12d defines a plate interspace 22″ between themselves.

Either each ridge 14 14′ 14″ 14′″ has brazing material 16 16′ 16″ 16′″ applied to it, or the brazing material 16′ 16″ 16′″ is applied to the opposite plate. In particular, the ridges 14″ 14′″ of the third substantially flat plate 12c and the fourth substantially flat plate 12d have brazing material 16″ 16′″, and, the second substantially flat plate 12b and the third substantially flat plate 12d have brazing material 16′ 16″ opposite the ridges 14 14′.

FIG. 3B shows a side cross sectional view of the stack of substantially flat plates 10″ when the first substantially flat plate 12a, the second substantially flat plate 12b, the third substantially flat plate 12c and the fourth substantially flat plate 12d have been brazed together, similar to FIG. 1B.

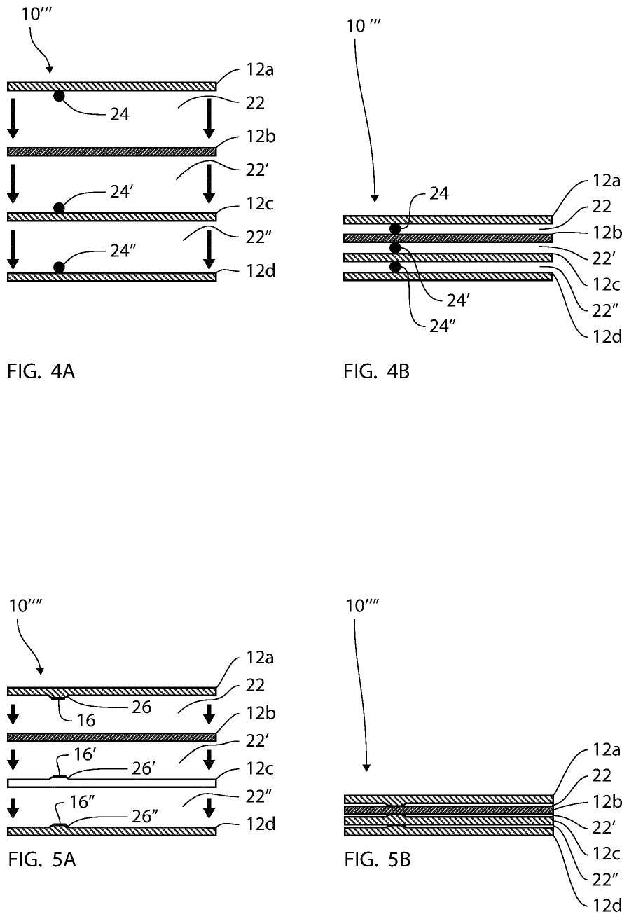

FIG. 4A shows a side cross sectional view of a stack of substantially flat plates 10′″ defining a first substantially flat plate 12a, second substantially flat plate 12b, a third substantially flat plate 12c and a fourth substantially flat plate 12d. The first substantially flat plate 12a and the second substantially flat plate 12b defines a plate interspace 22 between themselves, the third substantially flat plate 12c and the second substantially flat plate 12b defines a plate interspace 22′ between themselves, and, the third substantially flat plate 12c and the fourth substantially flat plate 12d defines a plate interspace 22″ between themselves. Each plate interspace 22 22′ 22″ comprises a rod 24 24′ 24″ having a diameter less than the thickness of the plates. (The rods have been exaggerated for better visibility.)

The rods 24 24′ 24″ can be covered by brazing material, or alternatively the brazing material may be applied to the plates adjacent the rods 24 24′ 24″.

FIG. 4B shows a side cross sectional view of the stack of substantially flat plates 10″ when the first substantially flat plate 12a, the second substantially flat plate 12b, the third substantially flat plate 12c and the fourth substantially flat plate 12d have been brazed together at the rods 24 24′ 24″. The circular shape of the rods 24 24′ 24″ allows brazing material to accumulate at the rods 24 24′ 24″ similar to the curvature of the ridge. Using rods avoids valleys on the plate and thus the rods 24 24′ 24″ can be located without any offset.

FIG. 5A shows a side cross sectional view of a stack of substantially flat plates 10′″ defining a first substantially flat plate 12a, second substantially flat plate 12b, a third substantially flat plate 12c and a fourth substantially flat plate 12d. The first substantially flat plate 12a and the second substantially flat plate 12b defines a plate interspace 22 between themselves, the third substantially flat plate 12c and the second substantially flat plate 12b defines a plate interspace 22′ between themselves, and, the third substantially flat plate 12c and the fourth substantially flat plate 12d defines a plate interspace 22″ between themselves. Each plate interspace 22 22′ 22″ comprises a coined ridge 26 26′ 26″ having a height less than the thickness of the plates. Coining is a specific technique which differs from pressing in that is does not produce a valley on the opposite side of the plate. The coined ridges 26 26′ 26″ can be covered by brazing material similar to a pressed ridge.

FIG. 5B shows a side cross sectional view of the stack of substantially flat plates 10″ when the first substantially flat plate 12a, the second substantially flat plate 12b, the third substantially flat plate 12c and the fourth substantially flat plate 12d have been brazed together at the coined ridges 26 26′ 26″. The curved shape of the coined ridges 26 26′ 26″ 24 24′ 24″ allow brazing material together with melted plate material to accumulate at the coined ridges 26 26′ 26″, similar to a pressed ridge. However, using coined ridges 26 26′ 26″ avoids valleys on the plate and thus the coined ridges 26 26′ 26″ 24 24′ 24″ can be located without any offset.

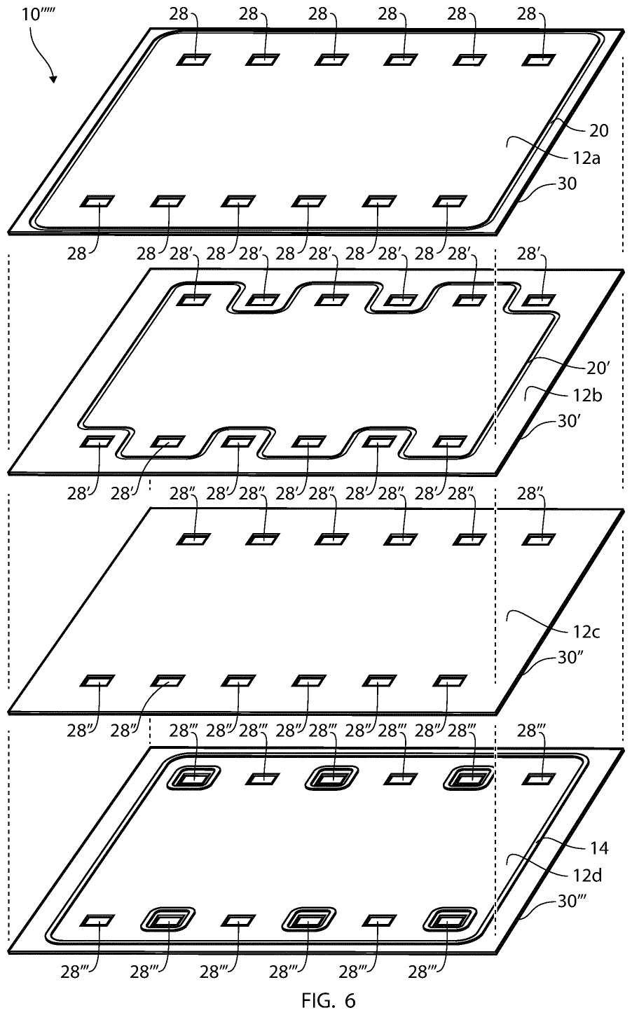

FIG. 6 shows a perspective view of a stack of substantially flat plates 10′″″ according to the present invention. The stack 10′″″ can for instance be a fuel cell substate or electrolyser part. The stack 10′″″ comprising a first substantially flat plate 12a, second substantially flat plate 12b, a third substantially flat plate 12c and a fourth substantially flat plate 12d. Each plate 12a 12b 12c 12d comprising a set of port holes 28 28′ 28″ 28′″.

The first substantially flat plate 12a comprises a pressed valley 20 encircling the first substantially plate 12a adjacent an edge 30 of the first substantially flat plate 12a. The valley 20 defines a ridge (not visible) on the opposite side of the first substantially flat plate 12a.

The second substantially flat plate 12b comprises a pressed valley 20′ encircling the first substantially plate 12a adjacent an edge 30′ of the second substantially flat plate 12a. The valley 20′ each define a ridge (not shown) on the opposite side of the first substantially flat plate 12a. The valley 20′ of the second substantially flat plate 12b is offset relative to the valley 20 of the first substantially flat plate 12a. In this way the ridge (not visible) of the first substantially flat plate 12a does not fall into the valley 20′ of the second substantially flat plate 12b.

The third substantially flat plate 12c only comprises port holes 28″, it does not comprise any ridges or valleys.

The fourth substantially flat plate 12d comprises a pressed ridge 14 encircling the fourth substantially plate 12d adjacent an edge 30′″ of the fourth substantially flat plate 12d. The ridge 14″ defines a valley (not visible) on the opposite side of the first substantially flat plate 12d.

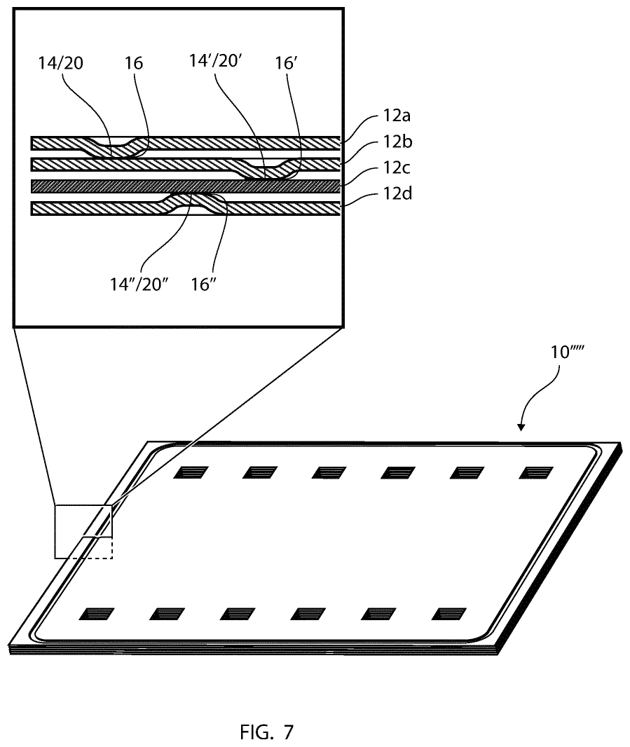

FIG. 7 shows a perspective view of the stack 10″″ of FIG. 6 as the plates have been permanently joined. The ridge 14 of the first substantially flat plate 12a joined to the second substantially flat plate 12b slightly offset to avoid that the ridge 14 of the first substantially flat plate 12a falls into the valley 20′ of the second substantially flat plate 12b. The ridge 14′ of the second substantially flat plate 12b and the ridge 14″ of the fourth substantially flat plate 12d are joined on to the third substantially flat plate 12c. The joining technique used can be brazing as previously described.

The ridges, rods and plate interspaces described herein have been exaggerated for better visibility.

1. A stack of substantially flat plates stacked one on top of the other along a stacking direction, the substantially flat plates defining at least a first plate interspace between a first plate and an opposing second plate of the stack, one of the plates in the first plate interspace defining a first ridge protruding a first distance in the first plate interspace, the first distance being less than the thickness of the plates in the first plate interspace, the plates in the first plate interspace being permanently joined at the first ridge.

2. The stack of plates according to claim 1, wherein the stack of substantially flat plates defining at least a second plate interspace between a third plate and one of the plates in the first plate interspace, one of the plates in the second plate interspace defining a second ridge protruding a second distance in the second plate interspace, the second distance being less than the thickness of the plates in the second plate interspace, the plates in the second plate interspace being permanently joined at the second ridge.

3. The stack of plates according to claim 2, wherein the stack of substantially flat plates defining at least a third plate interspace between a fourth plate and one of the plates in the first plate interspace or second plate interspace, one of the plates in the third plate interspace defining a third ridge protruding a third distance in the third plate interspace, the third distance being less than the thickness of the plates in the third plate interspace, the plates in the third plate interspace being permanently joined at the third ridge.

4. The stack of plates according to claim 1, wherein at least one of the ridges comprising a brazing material.

5. The stack of plates according to claim 1, wherein at least one of the ridges is coined or pressed, or the ridge is a cylindrical rod.

6. The plate stack according to claim 1, wherein at least one of the plates has a pressed ridge in one of the plate interspaces creating a valley on the opposite side of the plate, the ridges of adjacent plate interspaces being offset in relation to each other.

7. The plate stack according to claim 1, wherein at least one of the ridges encircling the plate adjacent an edge of the plate, or, wherein the plates comprise port holes and at least one of the ridges encircling the port hole.

8. A system comprising the plate stack according to claim 1, the system being a fuel cell or an electrolyzer.

9. A method of manufacturing a stack of substantially flat plates comprising the steps of:
stacking the substantially flat plates one on top of the other along a stacking direction, the substantially flat plates defining at least a first plate interspace between a first plate and an opposing second plate of the stack, one of the plates in the first plate interspace defining a first ridge protruding a first distance in the first plate interspace, the first distance being less than the thickness of the plates in the first plate interspace, and
permanently joining the plates in the first plate interspace at the first ridge.

10. The method according to claim 9, wherein the stack of substantially flat plates defining at least a second plate interspace between a third plate and one of the plates in the first plate interspace, one of the plates in the second plate interspace defining a second ridge protruding a second distance in the second plate interspace, the second distance being less than the thickness of the plates in the second plate interspace, the method comprising the step of permanently joining the plates in the second plate interspace at the second ridge.

11. The method according to claim 10, wherein the stack of substantially flat plates defining at least a third plate interspace between a fourth plate and one of the plates in the first plate interspace or second plate interspace, one of the plates in the third plate interspace defining a third ridge protruding a third distance in the third plate interspace, the third distance being less than the thickness of the plates in the third plate interspace, the method comprising the step of permanently joining the plates in the third plate interspace at the third ridge.

12. The method according to claim 9, further comprising the initial step of applying a brazing material onto at least one of the ridges.

13. The method according to claim 9, wherein at least one of the ridges are coined or pressed, or the ridge is a cylindrical rod.

14. The method to claim 9, wherein at least one of the plates has a pressed ridge in one of the plate interspaces creating a valley on the opposite side of the plate, the ridges of adjacent plate interspaces being offset in relation to each other.

15. The method according to claim 9, wherein at least one of the ridges encircles the plate adjacent an edge of the plate, or, wherein the plates comprise port holes and at least one of the ridges encircles the port hole.
